(19) United States
(12) Patent Application Publication
(10) Pub. No.: US 2015/0120274 A1
(43) Pub. Date: Apr. 30, 2015

(54) Language Translation System

(71) Applicant: Mark FORBUSH, Burlington, MA (US)

(72) Inventor: Mark FORBUSH, Burlington, MA (US)

(21) Appl. No.: 14/224,273

(22) Filed: Mar. 25, 2014

Related U.S. Application Data
(60) Provisional application No. 61/896,338, filed on Oct. 28, 2013.

(51) Int. Cl. G06F 17/28; G06Q 10/06

(52) U.S. Cl. CPC G06F 17/289; G06Q 10/06
USPC 704/2

(57) ABSTRACT

In a computerized device, a method for translating a text field includes receiving a first text field in a first language, accessing at least one translation database, and retrieving from the at least one translation database a second text field in a second language based upon the first text field in the first language, the second text field in the second language configured as a translation of the first text field in the first language. The method includes storing the first text field in the first language and the second text field in the second language as an audit entry in an audit entry database and outputting the second text field in the second language. The audit entry can include a translation attribute which provides information regarding the translation of the first text field, such as high level language information, geographic information, industry information associated and/or specific user information.

### RELATED APPLICATIONS

This patent application claims the benefit of U.S. Provisional Application No. 61/896,338, filed on Oct. 28, 2013, entitled, “Language Translation System,” the contents and teachings of which are hereby incorporated by reference in their entirety.

### BACKGROUND

Conventional enterprise resource planning (ERP) systems are configured to allow an organization to integrate and manage various aspects of its business using a single, computer implemented process. For example, ERP systems allow an organization to manage its production, inventory, and financial transactions via a graphical user interface (GUI) as provided at a user workstation.

Many organizations include facilities that are located internationally. Accordingly, to allow operation of the ERP system by users in their native language, conventional ERP systems typically include a language translation package. For example, conventional language translation packages are configured to translate static (i.e., unchanging) labels or titles displayed as part of the GUI from a first language, such as English, to a second language, such as German. With such translation, conventional language translation packages allow an organization to provide local-language use of the organization's ERP system without requiring modification of the organization's ERP system and without requiring the organization make changes to its database.

### SUMMARY

Conventional language translation packages suffer from a variety of deficiencies. For example, as indicated above, conventional language translation packages used in conjunction with ERP systems are configured to translate statically displayed content, such as a GUI's displayed labels or titles. However, conventional language translation packages are not configured to translate dynamic or user input text (e.g., text entered into the fields provided by the GUI). Accordingly, an ERP operator working in a first language (English) may not be able to understand the text entered into the ERP system by a user working in a second language (German). Alternately, an ERP operator working in a first location (United States) may not be able to understand the text entered into the ERP system by a user working in a second location (Germany). Additionally, conventional ERP systems require the maintenance of an audit trail for any data changed within the system. Conventional language translation packages are not configured to provide such an audit trail of language translations.

By contrast to conventional translation packages, embodiments of the present innovation relate to a language translation system, such as used in conjunction with an organization's ERP system. In one arrangement, the language translation system translates user-input text from a first language to one or more second languages. The language translation system stores the user-input text as well as the translated text to a database and maintains an audit trail associated with the translation. For example, the audit trail can include the source, date, time, approver, and version of each translation. The language translation system then outputs the translated text, such as via a display, to the user. In one arrangement, the language translation system includes one or more translation attributes as part of the audit trail. The translation attribute is configured to provide information regarding the translation of the first text field to the second text field, such as language information, geographic information, and/or industry information associated with the translation.

In one arrangement, in a computerized device, a method for translating a text field includes receiving a first text field in a first language, accessing at least one translation database, and retrieving from the at least one translation database a second text field in a second language based upon the first text field in the first language, the second text field in the second language configured as a translation of the first text field in the first language. The method includes storing the first text field in the first language and the second text field in the second language as an audit entry in an audit entry database and outputting the second text field in the second language. The second language displayed or printed will be based on the user's language choice.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic depiction of a language translation system, according to one arrangement.

FIG. 2 illustrates an example of a graphical user interface provided by a server device of the language translation system, according to one arrangement.

FIG. 3 is a flowchart that illustrates the operation of a server device of the language translation system of FIG. 1, according to one arrangement.

FIG. 4 illustrates a schematic depiction of a language translation system having a developing translation database, according to one arrangement.

FIG. 5 illustrates a schematic depiction of a server device of the language translation system of FIG. 1 having a translation attribute, according to one arrangement.

FIG. 6 illustrates a schematic depiction of a global translation database disposed in electrical communication with multiple server devices.

### DETAILED DESCRIPTION

Embodiments of the present innovation relate to a language translation system, such as used in conjunction with an organization's ERP system. In one arrangement, the language translation system translates user-input text from a first language to one or more second languages. The language translation system stores the user-input text as well as the translated text to a database and maintains an audit trail associated with the translation. For example, the audit trail can include the source, date, time, approver, and version of each translation. The language translation system then outputs the translated text, such as via a display, to the user based upon the user's language choice. The language translation system can include one or more translation attributes as part of the audit trail. The translation attribute is configured to provide information regarding the translation of the first text field to the second text field, such as language information, geographic information, and/or industry information associated with the translation.

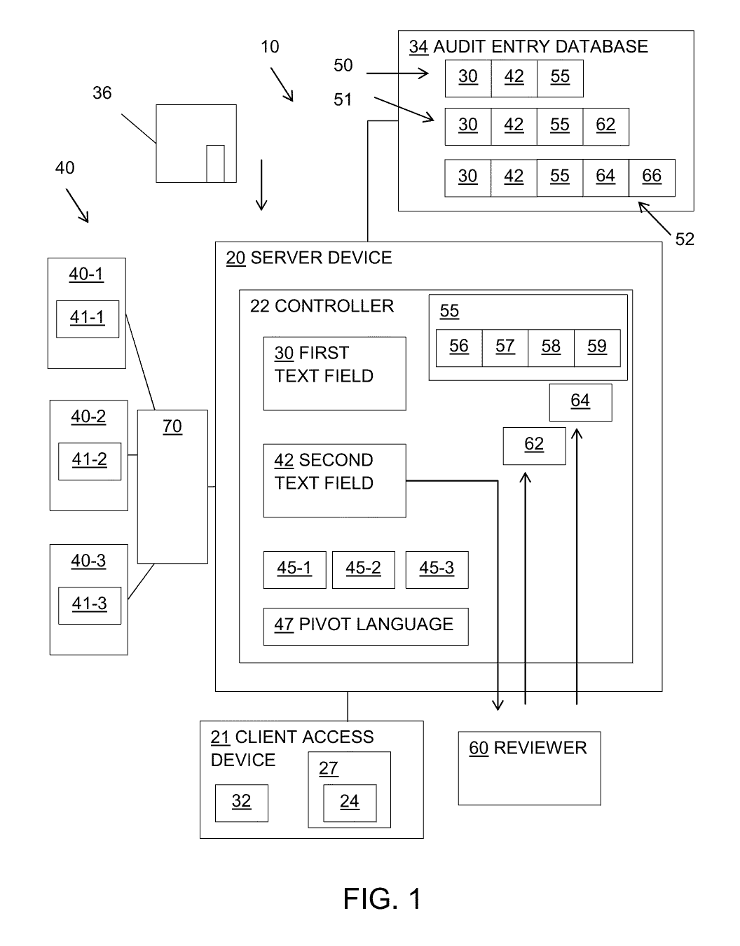

FIG. 1 illustrates an example of a language translation system 10. The language translation system 10 includes a first computerized device, such as a server device 20, and a second computerized device, such as client access device 21. The language translation system 10 also includes one or more translation databases 40 and an audit entry database 34, each of which is disposed in electrical communication with the server device 20.

The client access device 21 is disposed in electrical communication with the server device 20 and can be selected from a variety of computerized devices. For example, the client access device 21 can be a personal computer, laptop computer, tablet computerized device, or smartphone device. In use, the client access device 21 is configured to access the server device 20 with respect to production, inventory, and financial transactions associated with an organization's ERP system.

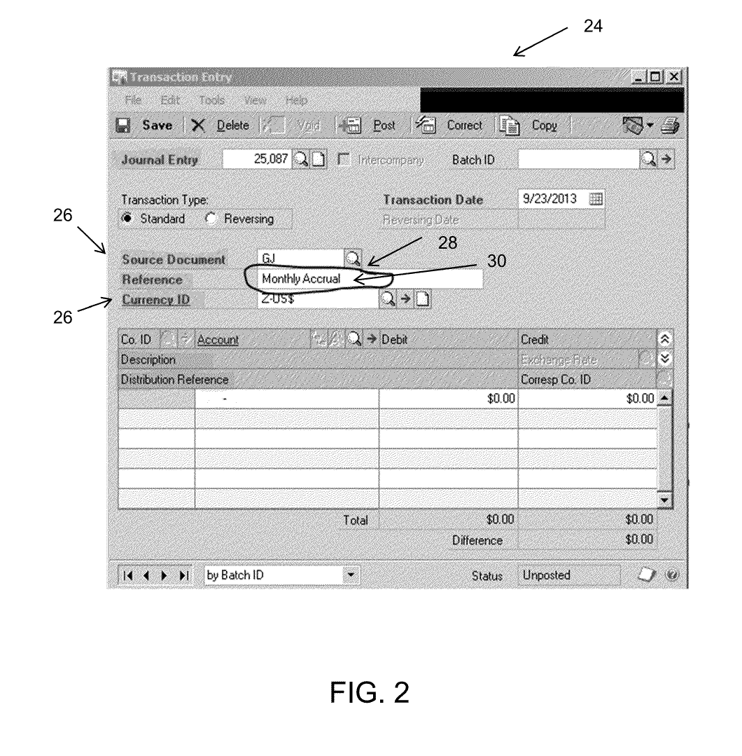

The server device 20 includes a controller 22, such as a processor and a memory, configured to execute an ERP system application which allows an organization associated with the server device 20 to manage its production, inventory, and financial transactions. For example, the controller 22 of the server device 20 is configured to generate and provide a GUI 24, such as illustrated in FIG. 2, to a display 27 associated with the client access device 21 to allow a user to interact with the ERP system via the server device 20. The GUI 24 is configured to display both static (i.e., unchanging) labels 26 and text field input locations 28. With reference to FIG. 1, an operator can enter dynamic text field strings (hereinafter termed text fields) 30 into the text field input locations provided by the GUI 24 using an input device 32, such as a keyboard, associated with the client access device 21. In one arrangement, the server device 20 is configured to provide the GUI 24 in a language of an operator (e.g., English, Spanish, etc.).

The controller 22 is also configured to execute a language translation application in conjunction with the ERP system application. For example, the language translation application configures the controller 22 to translate the text fields 30 from an input language to a second language. As will be described in detail below, the language translation application also configures the controller 22 to store an input text field 30 and translated text of the input text field 30 in an audit entry database 34.

The language translation application installs on the controller 22 from a computer program product 36 as shown in FIG. 1. In certain arrangements, the computer program product 36 is available in a standard off-the-shelf form such as a shrink wrap package (e.g., CD-ROMs, diskettes, tapes, or flash drives). In other arrangements, the computer program product 36 is available in a different form (e.g., propagated signals, a network installation, or downloadable online media). In still other arrangements, the computer program product 36 is part of a storage medium contained within the server device 20 as part of a memory from which such an application may be loaded.

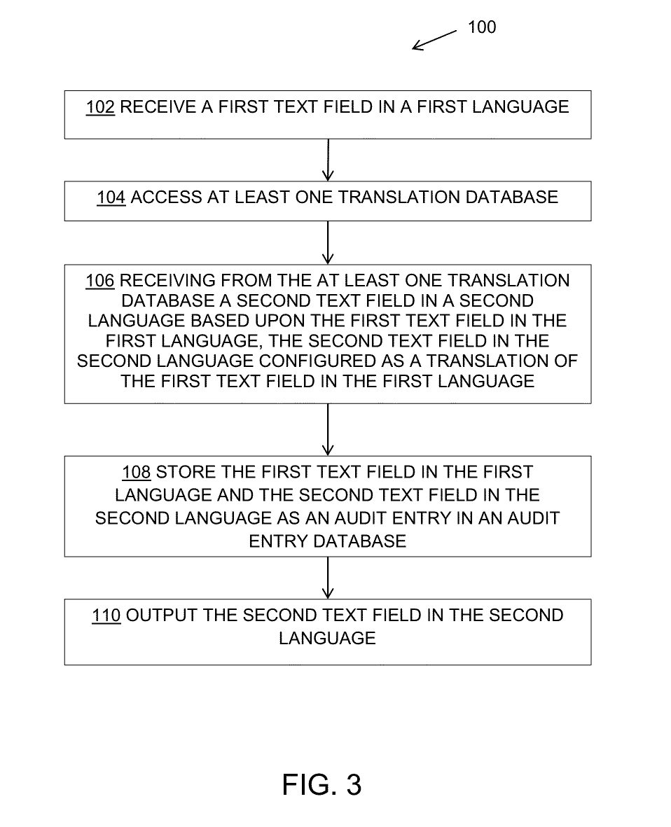

When executing the language translation application, the server device 20 is configured to translate text fields 30 entered by a user in a first language into any number of second languages. For example, assume the case where an organization includes users who communicate in English, Italian, Korean, and Spanish. In such a case, the server device 20 can be configured to provide the GUI 24 to each user group in a given default language (e.g., English) and to translate the received text fields 30 into the other languages (e.g., Italian, Korean, and Spanish) to allow other non-English users associated with the organization to access the text fields 30 in their native languages. FIG. 3 is a flowchart 100 that illustrates an example of the operation of the server device 20 when translating the dynamic text fields 30, as received via the GUI 24, from a first language to a second language.

During operation, and as shown in element 102, the server device 20 receives a first text field 30 in a first language. With reference to FIG. 2, the server device 20 provides a GUI 24 having text field inputs 28 to the client access device 21 for display by the display device 27. For example, with additional reference to FIG. 1, assume the server device 20 is configured to provide the GUI 24 to the client access device 21 in English as the default language. With such display, a user can input a text field 30 in a first language, such as the English language, into a text field input 28 using the input device 32. As the user enters the text field 30, the GUI 24 displays the text field 30 to the user via the display device 27. The user then provides the edited GUI 24 to the server device 20 by saving the edited GUI 24 (e.g., the form, screen, or record) to a records or ERP database (not shown) associated with the device 20.

Returning to FIG. 3, as indicated in element 104, the server device 20 then accesses at least one translation database 40. For example, assume that the server device 20 is configured to translate the English text fields 30 into German for the German speaking workers associated with the organization. With reference to FIG. 1, in response to the user saving the record (i.e., the server device 20 receiving the first text field 30), the server device 20 is configured to access any number of translation databases 40, such as via a gateway server device 70, to translate the first text field 30 to a second language (i.e., German).

In one arrangement, the server device 20 is configured to access one or more translation databases 40 that are external (i.e., unsecured and uncontrolled) relative to the ERP system associated with the server device 20. For example, the server device 20 can access GOOGLE TRANSLATE, YAHOO SYSTRAN, or MICROSOFT BING TRANSLATOR as the external translation databases via a wide area network (WAN). In another arrangement, the server device 20 is configured to access translation databases 40 that are internal to an organization associated with the server device 20, such as installed language dictionaries on a local area network (LAN). In the case where the translation databases 40 are internal to the organization, the organization can secure or limit access to the databases 40 to maintain the integrity of the data contained therein.

Returning to FIG. 3, as indicated in element 106, the server device 20 is configured to receive from the at least one translation database 40 a second text field 42 in a second language based upon the first text field 30 in the first language. In such a case, the second text field 42 is a translation of the first text field 30. For example, based upon the configuration of the server device 20 (e.g., as set by the language translation application or by the user), the server device 20 can retrieve foreign language equivalents to the first text field 30 in one or more second languages, such as German, Italian, Korean, and/or Spanish.

For example, with reference to FIG. 1, assume the server device 20 receives the first text field 30 in a first language, such as English, and is configured to translate the text field 30 to the German language. In such a case, based upon the English language first text field 30 the server device 20 reviews the databases 40 for a correspondence between the first text field 30 and tables 41, stored within the databases, that include German text fields. In one arrangement, when the server device 20 detects, in any of the databases 40, a table containing German text fields as well as a field in the table 41 having a German language equivalent to the first text field 30, the server device 20 retrieves the German language equivalent as the second text field 42. In another arrangement, the server device 20 accesses the tables 41 in the databases 40 to obtain multiple translations for the first text field 30 and selects the most common translation as the correct translation for the second text field 42.

Returning to FIG. 3, as indicated in element 108, the server device 20 stores the first text field 30 and the second text field 42 as an audit entry 50 in an audit entry database 34. In one arrangement, the audit entry database 34 is configured as an ERP database. As indicated above, conventional ERP systems require the maintenance of an audit trail for any data changed within the system. Accordingly, to provide an audit trail with respect to the translation of the first text field 30 to the second text field 42, the server device 20 stores both the first and second text fields 30, 42 (e.g., the original English and the translated German text fields) as a single audit entry 50 in the audit entry database 34.

In one arrangement, the server device 20 stores the first and second text fields 30, 42 along with one or more translation attributes 55 as part of the audit entry 50. The translation attribute 55 is configured to provide information regarding the translation of the first text field 30 from the first language into the second text field 42 in the second language. For example, the server device 20 can include as the translation attribute 55 information regarding the source of the translation (e.g., the database, table, and field associated with the retrieval of the second text field 42), the date of the translation, and the time of the translation.

In another example, the translation attribute 55 can include a language information entry 56 associated with the second text field 42, geographic location information entry 57 such as associated with an organization requesting the translation of the first text field 30, an industry information entry 58 such as associated with the requesting organization, and an individual user information entry 59 for a user affiliated with the organization, such as the user operating the client access device 21.

In one arrangement, the language information entry 56 identifies the primary or base language associated with the translated second text field 42, as well as a secondary or dialect associated with the primary language translation. For example, assume the case where the server device 20 is configured to translate the first text field 30 from English into a Spanish. While the primary or base language associated with the translated second text field 42 is Spanish, there are a number of different types of regional Spanish dialects (e.g., Latin American Spanish, European Spanish, etc.). The language information entry 56 allows the server device 20 to identify both the common base-level Spanish language associated with the translation of the first text field 30, and any particular dialects (e.g., Mexican, European, etc.) associated with the translation.

In one arrangement, translation attribute 55 includes the entries 56 through 59 in a hierarchical or nested configuration to identify the relationship among the factors that lead to the translation of a particular first text field 30 to a second text field 42. For example, the translation attribute 55 can identify that the translation of the first text field 30 into the second text field 42 was created for a specific language (e.g., Spanish), for a specific geographic location (e.g., Mexico), for a specific company (e.g., golf ball manufacturer), and for a specific user at the company (e.g., Paul).

Returning to FIG. 3, as indicated in element 110, the server device 20 then outputs the second text field 42 in the second language. For example, once the server device 20 has translated the first English text field 30 to the second German text field, the server device 20 allows other client access devices 21 in the system 10 to view the second text field in the German language. For example, when a client access device 21 operated by German-speaking users retrieves a stored GUI from the server device 20, the server device can provide the GUI 24 with the second text fields 30 in the translated German text, rather than in the original English text.

With the example system configuration of FIG. 1, the server device 20 provides a real-time translation of the first text field 30 to the second text field 42. Accordingly, the language translation system 10 provides an ERP system with the ability to translate user-input text from a first language to one or more second languages while maintaining an audit trail associated with the translation.

In certain cases, the translation databases 40 may not take into account various dialects or usages of particular words or phrases. Accordingly, there is the possibility that the server device 20 can retrieve a second text field 42 from the databases 40 that does not represent an accurate translation of the first text field 30. In one arrangement, the language translation system 10 is configured to allow for a review of the accuracy of the second, translated text field 42.

For example, with reference to FIG. 1, the server device 20 is configured to forward the first and second text fields 30, 42 to a reviewer 60 for a review of the translation of the first text field 30. In one arrangement, the reviewer 60 can be a person, an application executed by the server device 20, or a second computerized device that reviews the accuracy of the translation of the first text field 30 to the second text field 42. Due to the variability of words in any language based on regional dialects and/or slang, this review process provides customers with the option to change any inaccurate translation to a more accurate translation.

In one arrangement, as a result of the review, the server device 20 receives an approval notification 62 from the reviewer 60 when the reviewer 60 confirms the second text field 42 as being an accurate translation of the first text field 30. Once a word or phrase has been approved by the reviewer 60 via the approval notification 62, the server device 20 stores this notification 62, as well as the first and second text fields 30, 42 as part of a local, developing translation database 63. As will be described below with reference to FIG. 3, by building the developing translation database 63 with approved translations of words and phrases, the language translation system 10 can utilize the local database 63 for translations and minimize the use of both the external translation databases 40 and the reviewer 60.

In one arrangement, the server device 20 is configured to include information regarding the approval notification 62 within an audit entry 51 for the translation. For example, the server device 20 can store the first and second text fields 30, 42, information regarding the source of the translation, the approval notification 62, and information related to the reviewer, such as time, date, and reviewer information associated with the approval notification 62. Additionally, the server device 20 can include as part of the audit entry 51 a translation attribute 55, such as having a language information entry 56 identifying the base language of the translation of the second text field 42. In such an arrangement, the server device 20 can maintain a detailed accounting of the translation of the first text field 30.

In one arrangement, in the case where the reviewer 60 detects the second text field 42 as being an inaccurate translation of the first text field 30, the server device 20 can receive a modified second text field 64 from the reviewer 60. For example, based upon dialects, slang, and/or industry usage, the reviewer 60 can provide the modified second text field 64 as its own translation of the first text field 30. Accordingly, the modified second text field 64 represents a translation of the first text field 30 which has an increased level of accuracy relative to the second text field 42 retrieved from the database 40. In such an arrangement, the server device 20 is configured to output the modified second text field 64 as part of the saved GUI 24 to client access devices 21 configured to view the GUI 24 in the language of the modified second text field 64.

In one arrangement, the server device 20 is configured to store the modified text field 64 along with original text field 30 and translated text field 42 as an audit entry 52 in the audit entry database 34. With such a configuration, the server device 20 provides an audit trail with respect to the translation of the first text field 30 to the second text field 42, as well as the modification of the first text field 30 to the modified text field 64. The server device 20 is also configured to include additional information 66 regarding the modified text field as part of the audit entry 52. For example, the server device 20 can include information 66 regarding time, date, and reviewer information associated with the modified text field 64 as part of the audit entry 52. Additionally, the server device 20 can include as part of the audit entry 52 a translation attribute 55 such as having a language information entry 56 identifying the base language of the translation of the second text field 42 as well as a regional dialect and/or slang associated with the modified text field 64.

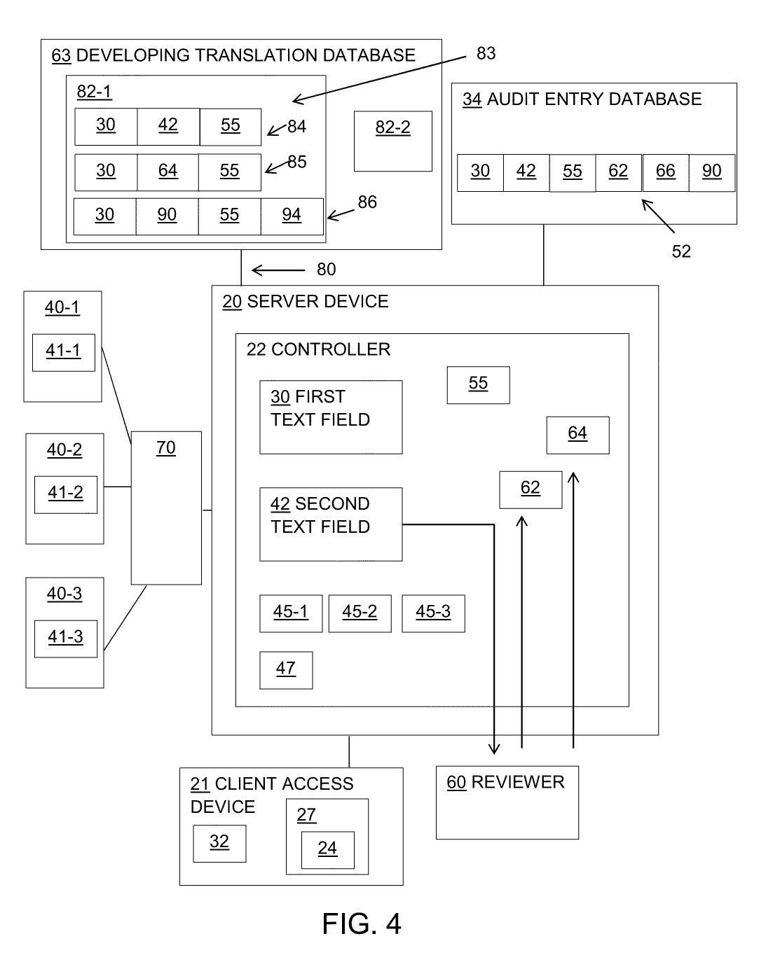

As indicated above, in response to receiving a first text field 30, the server device 20 can access the translation database 40 to acquire an appropriate translation. However, to minimize time and effort required to obtain a translation for a first text field 30 and to maintain consistency and accuracy for a given translation, an organization can establish and maintain its own developing translation database 63, as illustrated in FIG. 4.

The developing translation database 63 is disposed in communication with the server device 20. For example, the developing translation database 63 and the server device 20 can include a secure communications channel 80, such as a secure network channel, disposed there between. The secure communications channel 80 can limit or prevent an unauthorized user from accessing the developing translation database 63. While the developing translation database 63 can be configured in a variety of ways, in one arrangement, the database 63 includes a set of tables 82, each table 82 listing a set of first text fields 30 in a first language and corresponding second text fields 42 in a second, translated language. Accordingly, for a given first source language (e.g., English) each table of the set of tables 82 can be associated with a particular translation language (e.g., a first table 82-1 for translations into French and a second table 82-2 for translations into German).

In one arrangement, the server device 20 is configured to build the developing translation database 63 over time to include a set of entries 83. For example, assume the case where the server device 20 receives a first text field 30 from the client access device 21 and a translated second text field 42 from the translation database 40. In the case where the server device 20 receives an approval notification 62 from the reviewer 60 regarding the text field 42, the server device 20 is configured to store the original text field 30 and either the translated text field 42 as an entry 84 in a corresponding table 82 in the developing translation database 63. For example, in the case where the translation of the first text field 30 is from English to French, the server device 20 is configured to create an entry 84 which includes the English first text field 30 and the French second text field 42 in the English-to-French translation table 82-1. In another example, the server device 20 can store the first text field 30 and an associated modified text field 64 as an entry 85 in a table 82 of the developing translation database 63. As indicated above, in use, the reviewer 60 can provide a modification the second text field 42 to the server device 20. In response, the server device 20 is configured to store the original text field 30 and the modified text field 64 as an entry 85 in the developing translation database 63.

In one arrangement, entries 84, 85 can include one or more translation attributes 55 associated with the translation of the first text field 30. For example, as indicated above, the translation attribute 55 can identify an industry associated with the entries 84, 85, a geographical location of the industry, a base language and/or a dialect associated with either the second text field 42 or the modified text field 64 of the entries 84, 85 or an identity of the reviewer 60. Additionally, the translation attribute 55 can indicate the translation database 40 utilized for the translation of the first text field 30 (e.g., GOOGLE TRANSLATE, YAHOO SYSTRAN, or MICROSOFT BING TRANSLATOR).

As indicated above, to maintain the integrity of the translations stored by the developing translation database 63, the developing translation database 63 is disposed in communication with the server device 20 via a secured connection 80. However, in one arrangement, an administrator, such as a system administrator, can access the developing translation database 63 and update either the translated text field 42 obtained from the translation database 40 or the modified text field 64 received from the reviewer 60 to generate an entry 86 having an updated text field 90. For example, assume the administrator accesses entry 85 in table 82-1 via the server device 20 and determines that the modified text field 64 is inaccurate. In such a case, the administrator can adjust the modified text field 64 to generate the updated text field 90. The server device 20 can then store a new entry 86 having the first text field 30 and the updated text field 90 in the developing translation database 63 to replace the original entry 85. Furthermore, the server device 20 can adjust the corresponding audit entry 52 in the audit entry database 34 to include the updated text field 90.

In one arrangement, the entry 86 can include one or more update attributes 94 associated with the updating of the modified text field 64. For example, the update attribute 94 can identify the date and administrator updating and/or approving the translation.

In use, as the server device 20 grows the developing translation database 63 with accurate translations for the first text field 30 received from the client access device 21, the server device 20 can utilize the developing translation database 63 as a default database prior to accessing the external databases 40. This can ensure the accuracy of translations and can minimize the need to rely upon both the external translation databases 40 and the reviewer 60, thereby speeding the translation process.

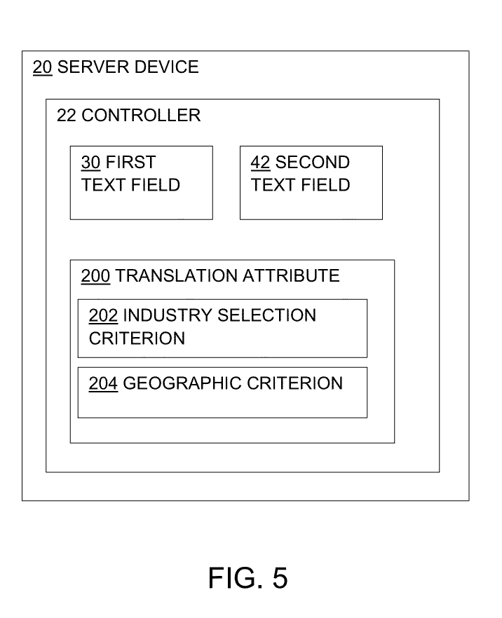

For example, in response to receiving the first text field 30, the server device 20 can first access the developing translation database 63 to detect if the first text field 30 is present in the database 63. With such access, the server device 20 can review a particular table 82 for a match between the received first text field 30 and that of an entry 83 in the table 82. In the case where the server device 20 detects a match, the server device 20 retrieves the corresponding second text field 42 (i.e., the translation to the first text field 30) from the table 82. In the case where the server device 20 detects an absence of a correspondence between the received first text field 30 and a first text field of an entry 84, 85 of the table 82, the server device 20 is configured to access one or more external translation databases 40 which are external to the ERP system associated with the server device 20. When the server device 20 received the translated second text field 42, the server device 20 can place the second text field 42 under the approval or modification process with the reviewer 60, as described above, and can save either the second text field 42 or the modified text field 64 to the developing translation database 63. As indicated above, the server device 20 is configured to access one or more of the external translation databases 40 (e.g., GOOGLE TRANSLATE, YAHOO SYSTRAN, or MICROSOFT BING TRANSLATOR) in response to receiving a first text field 30. In one arrangement, as indicated in FIG. 5, the server device 20 is configured to access a particular translation database 40 based upon a translation selection attribute 200, such as associated with either the ERP system (e.g., where the server device 20 is preconfigured with one or more translation selection attributes 200) or as associated with the received first text field 30.

In one arrangement, the translation selection attribute 200 relates to a particular industry associated with the ERP system 10. For example, the server device 20 can be configured with an industry selection criterion 202 from a user which indicates an industry associated with the ERP system (e.g., plumbing, aerospace, etc.). During operation, in response to receiving a text field 30, the server device 20 reviews the industry selection criterion 202 and is configured to access a translation database 40-1, 40-2 based upon a correspondence between the industry selection criterion 202 and an industry information entry 58 associated with the translation attribute 55 stored as part of the database 40. For example, assume the case where the industry selection criterion 202 identifies the ERP system as being associated with the aerospace industry. Based on this industry selection criterion, when the server device 20 receives the first text field 30, the server device 20 reviews each database 40-1 or 40-2 for translation text having an industry information entry 58 identifying the aerospace industry as part of the translation attribute 55. Use of a correspondence between the industry selection criterion 202 and a particular industry information entry 58 in a database 40 can increase the accuracy of the translation.

In one arrangement, the translation selection attribute 200 relates to a geographic location of the end user. For example, the server device 20 can be configured to detect a geographic location criterion 204 of one or more end users. During operation, in response to receiving a text field 30, the server device 20 reviews the geographic location criterion 204 and is configured to access a translation database based upon a correspondence between the received geographic location criterion 204 and an geographic information entry 57 associated with the translation attribute 55 stored as part of the database 40.

In one arrangement, the translation selection attribute 200 relates to both a particular industry associated with the ERP system and to a geographic location of the end user. During operation, in response to receiving a text field 30, the server device 20 reviews the industry selection criterion 202 and the geographic location criterion 204 and is configured to access a translation database 40 based upon both industry associated with the ERP system and based upon the geographic location of the end user. Because various areas in the world use different terms even within a particular industry, such a configuration of the ERP system enhances the accuracy of the translations.

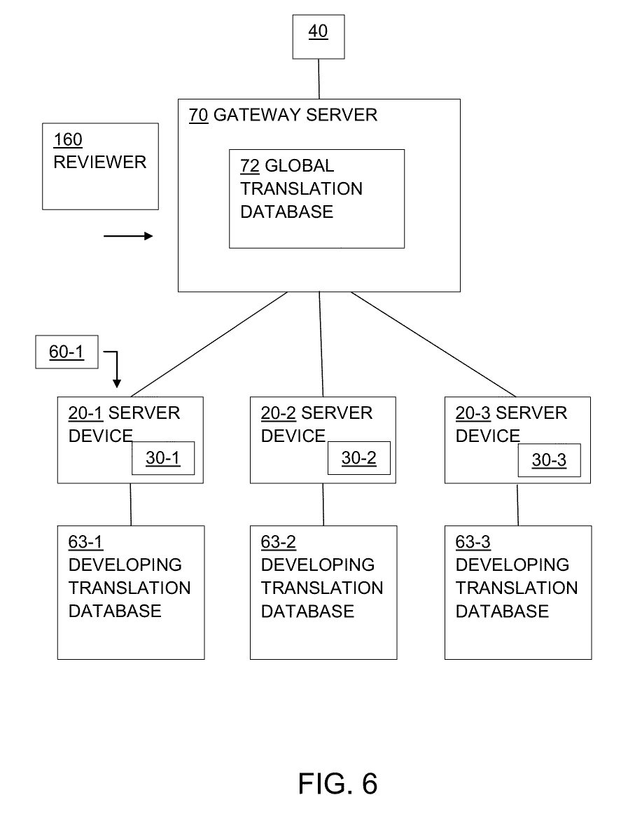

As indicated above with reference to FIG. 1, the server device 20 can access any number of translation databases 40 via a gateway server 70. In one arrangement, as illustrated in FIG. 6, the gateway server device 70 is disposed in electrical communication with a number of server devices 20-1 through 20-3. Each of the server devices 20-1 through 20-3 can be associated with different organizations or with the same organization.

In use, as each of the server devices 20-1 through 20-3 request translations of their respective first text fields 30-1 through 30-3, as the gateway server device 70 retrieves the corresponding second text field translations, the gateway server device 70 adds the first text field 30 and the second text field 42, along with associated translation attributes 55, as an entry in a global translation database 72. The gateway server device 70 can build the global translation database 72 to minimize time and effort required to obtain a translation for a first text field 30 and to maintain consistency and accuracy for a given translation for a particular an organization.

In one arrangement, the gateway server device 70 and the server devices 20-1 through 20-3 are configured to exchange updated translation information with each other to maintain the consistency of the global translation database 72 and the developing translation databases 63-1 through 63-3 over time. For example, in the case where a reviewer 160 updates the translation of a second text field 42 in an entry in the global translation database 72, the gateway server device 70 forwards the entry to one or more of the corresponding server devices 20-1 through 20-3 for addition to the corresponding developing translation database 63-1 through 63-3. In another example, in the case where a reviewer 60-1 updates the translation of a second text field 42 in an entry in a developing translation database 63-1, the server device 20-1 forwards the updated entry to the gateway server device 70 for addition to the global translation database 72.

While various embodiments of the innovation have been particularly shown and described, it will be understood by those skilled in the art that various changes in form and details may be made therein without departing from the spirit and scope of the innovation as defined by the appended claims.

For example, as indicated above, the server device 20 is configured to translate a received first text field 30 by accessing ether an external database 40 or a developing translation database 63 maintained internally by an organization. Such indication is by way of example only. In one arrangement, the client access device 21 is configured to access either the external database 40 or the developing translation database 63 to translate the first text field 30. In this arrangement, the translation occurs on a user level, rather than on a server level.

In another example, as indicated above, the server device 20 is configured to retrieve from the at least one translation database 40 a second text field 42 in a second language based upon the first text field 30 in the first language where the second text field 42 is a translation of the first text field 30. In one arrangement, to maximize the accuracy of the translation, the server device 20 is configured to access each of the databases 40 to obtain a set of translations of the first text field 30, such as one translation per database 40. In the case where the server device 20 detects a correspondence between at least two translations selected from two distinct databases 40, the server device 20 selects that translation as the second text field 42 corresponding to the first text field 30.

For example, with reference to FIG. 1, assume the first database 40-1 is configured as a GOOGLE TRANSLATE database, the second database 40-2 is configured as a YAHOO SYSTRAN database, and the third database 40-3 is configured as a MICROSOFT BING TRANSLATOR database. Following receipt of the first text field 30 in a first language (e.g., the word “fromage” in French), the server device 20 is configured to access the databases 40-1 through 40-3 to retrieve translations 45-1 through 45-3 corresponding to the first text field 30 in a second language (e.g., English). The server device 20 then compares the translations 45-1 through 45-3 to determine if any of the translations 45-1 through 45-3 are substantially similar to each other. For example, if translations 45-1 and 45-2 are both the word “cheese” and the third translation 45-3 is the phrase “milk product”, based upon a substantial correspondence between the translations 45-1 and 45-2, the server device 20 can select the translation “cheese” as the second text field 42.

In the case where the server device 20 detects an absence of a correspondence among the translations, the server device 20 is configured to select one of the databases 40-1 through 40-3 as the default translation database 40 and select the translation 45 from the default database as the second text field 42. For example, the server device 20 can be configured to select the first database 40-1 (e.g., GOOGLE TRANSLATE database) as the default translation database in the event where no correspondence is detected among the translations 45-1 through 45-3.

In another example, as described above, the server device 20 is configured to retrieve from the at least one translation database 40 a second text field 42 in a second language based upon the first text field 30 in the first language. In certain cases, however, the direct translation of a first language to a second language can lead to translation inaccuracies, such as when translating from a primary language (e.g., Arabic, Spanish, Chinese, or French and other European languages) to a secondary language (e.g., Japanese or German). In one arrangement as illustrated in FIG. 1, to minimize translation inaccuracies, the server device 20 is configured to retrieve a pivot language text field 47 as a translation bridge between the first text field 30 and the second text field 42.

For example, assume the server device 20 receives the first text field 30 in French and is configured to translate the first text field 30 into German. In this case, as part of a triangulation process, the server device 20 is configured to access the database 40 and retrieve a pivot language text field 47, such as an English translation of the first text field 30. The server device 20 then re-accesses the database 40 to retrieve a corresponding second text field 42 in the German language. The server device 20 can then store the first text field 30 and the second text field 42 as an entry in the developing translation database 63, forward the second text field to a reviewer 60 for approval or modification, and/or add an entry to the audit entry database 34 which includes a listing of the first text field 30, the pivot language text field 47, and the second text field 42.

In another example and as indicated above, following translation of the first text field 30 to the second text field 42, the server device 20 is configured to output the second text field 42 in the second language. In one arrangement, when outputting the second text field 42, the server device 20 is configured to store the first text field 30 and the second text field 42 to the developing translation database 63 prior to receiving an approval notification 62 or modification 64 from the reviewer 60. While the second text field 42 can be inaccurate, the presence of the first and second text fields 30, 42 in the developing translation database 63 provides the server device 20 with a readily available translation for the first text field 30 for subsequent uses. This translation (i.e., the second text field) can be reviewed by an administration or a reviewer 60 at a later date for approval or revision.

As indicated above, following the translation of the first text field 30 to the second text field 42, the server device 20 is configured to store the first text field 30 and the second text field 42 as an audit entry 50 in an audit entry database 34. In one arrangement, the server device 20 is configured to store any change or received data associated with the first text field 30 as an entry in the audit entry database 34.

In another example, as indicated above, the server device 20 is configured to build the developing translation database 63 over time to include a set of entries 83. In one arrangement, the server device 20 is configured to synchronize the developing translation database 63 with the external translation database 40, such as an industry-specific database, to update the second text fields 42 or modified text fields 64 of the entries 83. In another arrangement, when updating the developing translation database 63, the server device 20 creates entries that can be read and updated by machine language translation software.

In another example, as indicated above, the server device 20 can be configured to provide the GUI 24 to each user group in a given default language (e.g., English) and to translate the received text fields 30 into the other languages (e.g., Italian, Korean, and Spanish) to allow other non-English users associated with the organization to access the text fields 30 in their native languages. In one arrangement, the server device 20 is configured to provide the GUI 24 to the client access device 21 in a particular default language, such as English. In another arrangement, the server device 20 allows the user at the client access device 21 to select the originating language associated with the GUI 24, such as Spanish, and to toggle between the default language and the originating language displayed. Alternately, the server device 20 is configured to auto-detect the language associated with the client access device 21 and provide the GUI 24, including the text fields 30, to the client access device 21 in the detected language.

As indicated above, at any time, an administrator can access the developing translation database 63 and update either the translated text field 42 obtained from the translation database 40 or the modified text field 64 received from the reviewer to improve the translation, as needed. In one arrangement, the administrator can also access an ERP database associated with the language translation system 10 and for any given stored GUI 24, modify the either the translated text field 42 or the modified text field 64 to improve the translation, as needed. With such modification the server device 20 is configured to add an entry in the audit entry database identifying the modifications as well as the translation attributes 55 associated with the modification.

What is claimed is:

1. In a computerized device, a method for translating a text field, comprising:
receiving, by the computerized device, a first text field in a first language;
accessing, by the computerized device, at least one translation database;
receiving from the at least one translation database, by the computerized device, a second text field in a second language based upon the first text field in the first language, the second text field in the second language configured as a translation of the first text field in the first language; and
storing, by the computerized device, the first text field in the first language and the second text field in the second language as an audit entry in an audit entry database.

2. The method of claim 1, wherein storing the first text field in the first language and the second text field in the second language as an audit entry in an audit entry database comprises storing, by the computerized device, the first text field in the first language and the second text field in the second language as an audit entry in an enterprise resource planning (ERP) database.

3. The method of claim 1, wherein;
accessing the at least one translation database comprises accessing, by the computerized device, at least one external translation database, the at least one external translation database being external to an ERP system associated with the computerized device; and
receiving from the at least one translation database the second text field in the second language based upon the first text field in the first language comprises receiving from the at least one external translation database, by the computerized device, the second text field in the second language based upon the first text field in the first language.

4. The method of claim 3, comprising:
forwarding, by the computerized device, the second text field in the second language to a reviewer for review of the translation of the first text field in the first language to the second text field in the second language; and
receiving, by the computerized device, an approval notification of the second text field in the second language from the reviewer when the second text field in the second language is detected as an accurate translation of the first text field in the first language.

5. The method of claim 3, comprising:
forwarding, by the computerized device, the second text field in the second language for review of the translation of the first text field in the first language to the second text field in the second language; and
receiving, by the computerized device, a modified second text field in the second language, the modified second text field in the second language representing a translation of the first text field in the first language having an increased level of accuracy relative to the second text field in the second language.

6. The method of claim 3, wherein:
storing the first text field in the first language and the second text field in the second language as the audit entry in the audit entry database comprises storing, by the computerized device, the first text field in the first language, the second text field in the second language, and the modified second text field in the second language as the audit entry in the audit entry database.

7. The method of claim 3, further comprising storing, by the computerized device, a translation attribute as part of the audit entry in the audit entry database, the translation attribute configured as information regarding the translation of the first text field from the first language into the second text field in the second language.

8. The method of claim 5, further comprising:
storing, by the computerized device, the first text field and the second modified text field as an entry in a developing translation database, the developing translation database including a set of second text fields corresponding to a set of first text fields received by the computerized device.

9. The method of claim 8, further comprising storing, by the computerized device, a translation attribute as part of the entry in the developing translation database, the translation attribute configured as information regarding the translation of the first text field from the first language into the second text field in the second language.

10. The method of claim 1, wherein accessing the at least one translation database comprises accessing, by the computerized device, a developing translation database, the developing translation database including a set of second text fields corresponding to a set of first text fields received by the computerized device.

11. The method of claim 10, further comprising, in response to detecting an absence of correspondence between the first text field in the first language and a first text field of the set of first text fields in the developing translation database, accessing, by the computerized device, at least one external translation database, the at least one external translation database being external to an ERP system associated with the computerized device.

12. The method of claim 1, wherein:
accessing the at least one translation database comprises, in response to receiving the first text field in the first language, accessing, by the computerized device, the at least one translation database based upon at least one translation selection attribute associated with the first text field; and
retrieving from the at least one translation database the second text field in the second language based upon the first text field in the first language comprises retrieving, by the computerized device, from the at least one translation database the second text field in the second language based upon the at least one translation selection attribute associated with the first text field.

13. The method of claim 12, wherein the translation selection attribute is configured as at least one of a geographic criterion or an industry selection criterion.

14. A computerized device, comprising:
a controller configured to:
receive a first text field in a first language;
access at least one translation database;
receive from the at least one translation database a second text field in a second language based upon the first text field in the first language, the second text field in the second language configured as a translation of the first text field in the first language; and
store the first text field in the first language and the second text field in the second language as an audit entry in an audit entry database.

15. The computerized device of claim 14, wherein when storing the first text field in the first language and the second text field in the second language as an audit entry in an audit entry database, the computerized device is configured to store the first text field in the first language and the second text field in the second language as an audit entry in an enterprise resource planning (ERP) database.

16. The computerized device of claim 14, wherein the controller is further configured to
when accessing the at least one translation database, access at least one external translation database, the at least one external translation database being external to an ERP system associated with the computerized device; and
when receiving from the at least one translation database the second text field in the second language based upon the first text field in the first language, receive from the at least one external translation database the second text field in the second language based upon the first text field in the first language.

17. The computerized device of claim 16, wherein the controller is configured to:
forward the second text field in the second language to a reviewer for review of the translation of the first text field in the first language to the second text field in the second language; and
receive an approval notification of the second text field in the second language from the reviewer when the second text field in the second language is detected as an accurate translation of the first text field in the first language.

18. The computerized device of claim 16, wherein the controller is configured to:
forward the second text field in the second language for review of the translation of the first text field in the first language to the second text field in the second language; and
receive a modified second text field in the second language, the modified second text field in the second language representing a translation of the first text field in the first language having an increased level of accuracy relative to the second text field in the second language.

19. The computerized device of claim 18, wherein the controller is further configured to store a translation attribute as part of the audit entry in the audit entry database, the translation attribute configured as information regarding the translation of the first text field from the first language into the second text field in the second language.

19. The computerized device of claim 18, wherein the controller, when storing the first text field in the first language and the second text field in the second language as the audit entry in the audit entry database, is configured to store the first text field in the first language, the second text field in the second language, and the modified second text field in the second language as the audit entry in the audit entry database.

20. The computerized device of claim 16, wherein the controller is configured to:
store the first text field and the second modified text field as an entry in a developing translation database, the developing translation database including a set of second text fields corresponding to a set of first text fields received by the computerized device.

21. The computerized device of claim 20, wherein when storing the first text field and the second modified text field as an entry in the developing translation database, the controller is further configured to store a translation attribute as part of the entry in the developing translation database, the translation attribute configured as information regarding the translation of the first text field from the first language into the second text field in the second language.

22. The computerized device of claim 14, wherein the controller, when accessing the at least one translation database is configured to access a developing translation database, the developing translation database including a set of second text fields corresponding to a set of first text fields received by the computerized device.

23. The computerized device of claim 22, wherein the controller, in response to detecting an absence of correspondence between the first text field in the first language and a first text field of the set of first text fields in the developing translation database, is configured to access at least one external translation database, the at least one external translation database being external to an ERP system associated with the computerized device.
